(19) United States
(12) Patent Application Publication
(10) Pub. No.: US 2026/0255046 A1
(43) Pub. Date: Aug. 27, 2026

(54) ELECTRONIC DEVICE AND METHOD OF CONTROLLING ELECTRONIC DEVICE

(71) Applicant: CANON KABUSHIKI KAISHA, Tokyo (JP)

(72) Inventors: KENICHIRO SASAI, Kanagawa (JP); RYOHEI HAMAGUCHI, Mie (JP); RYOSUKE SATO, Kanagawa (JP)

(21) Appl. No.: 19/546,130

(22) Filed: Feb. 20, 2026

(30) Foreign Application Priority Data
Feb. 27, 2025 (JP) 2025-030172

(51) Int. Cl. H04N 23/63; H04N 23/61; H04N 23/69; H04R 1/32

(52) U.S. Cl. CPC H04N 23/63; H04N 23/61; H04N 23/69; H04R 1/326; H04R 2499/11

(57) ABSTRACT

An electronic device includes a processor and a memory storing instructions. When executed by the processor, the instructions cause the electronic device to execute detection processing of detecting an object from a captured image captured by an imaging device, and execute display control processing of performing control to display the captured image in a mode in which a sound collectable range, which is a range in which audio from the object is collectable in the captured image, is identifiable based on a distance from the imaging device to the object, a focal length of the imaging device, and information of a sound collection range by a sound collection unit that collects audio to be recorded together with the captured image.

### BACKGROUND

### Field of the Technology

The present disclosure relates to an electronic device and a method of controlling the electronic device.

### DESCRIPTION OF THE RELATED ART

An imaging apparatus (electronic device), such as a digital camera, capable of capturing a moving image and a still image and collecting audio includes an imaging unit and a sound collection microphone and can record audio specialized in a direction of an object, for example, together with an image of the object. Japanese Patent Laid-Open No. 2010-004303 discloses an imaging apparatus in which a range where sound can be picked up from a range of directivity of a sound collecting microphone (zoom microphone) is indicated by a frame on a shooting screen (so-called through screen). Japanese Patent Laid-Open No. 2022-180926 discloses a technique of specifying an object included in both a sound collection range and an imaging range as a sound collection target and adjusting an output volume so as to have a volume in a certain range based on a distance from the sound collection target.

The sound collection range of a sound collection microphone having directivity changes according to the distance between the object to be photographed and the sound collection microphone. For example, an appropriate sound collection range in the case of using a microphone having a narrow sound collection characteristic has a sound collection characteristic of being narrow in the case of short distance selfie photographing or the like and being wide in the case of photographing at a distance of several meters. In Japanese Patent Laid-Open No. 2010-004303 and Japanese Patent Laid-Open No. 2022-180926, since the sound collection range is determined without considering the distance between the object and the sound collection microphone, it is difficult for a user to accurately grasp the range in which the audio of the object can be collected.

### SUMMARY

Embodiments of the present disclosure provide an electronic device that enables a user to determine a photographing view angle while more accurately grasping a range in which audio of an object can be collected.

An electronic device according to the present disclosure includes a processor and a memory storing instructions. When executed by the processor, the instructions cause the electronic device to execute detection processing of detecting an object from a captured image captured by an imaging device, and execute display control processing of performing control to display the captured image in a mode in which a sound collectable range, which is a range in which audio from the object is collectable in the captured image, is identifiable based on a distance from the imaging device to the object, a focal length of the imaging device, and information of a sound collection range by a sound collection unit that collects audio to be recorded together with the captured image.

Features of various embodiments will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an imaging apparatus.

FIG. 2 is a diagram illustrating a directional microphone mounted on the imaging apparatus.

FIGS. 3A and 3B are diagrams illustrating a sound collection range according to a distance between an imaging apparatus and an object.

FIGS. 4A to 4C are diagrams illustrating conventional examples of presenting a sound collection range.

FIGS. 5A and 5B are diagrams illustrating a sound collection range at a first focal length.

FIGS. 6A and 6B are diagrams illustrating a presentation example of a sound collectable range at the first focal length.

FIGS. 7A and 7B are diagrams illustrating a sound collection range at a second focal length.

FIGS. 8A and 8B are diagrams illustrating a presentation example of a sound collectable range at the second focal length.

FIGS. 9A and 9B are diagrams illustrating a sound collection range when the object moves.

FIGS. 10A and 10B are diagrams illustrating a presentation example of the sound collectable range when the object moves.

FIG. 11 is a flowchart illustrating presentation processing of the sound collectable range.

### DESCRIPTION OF THE EMBODIMENTS

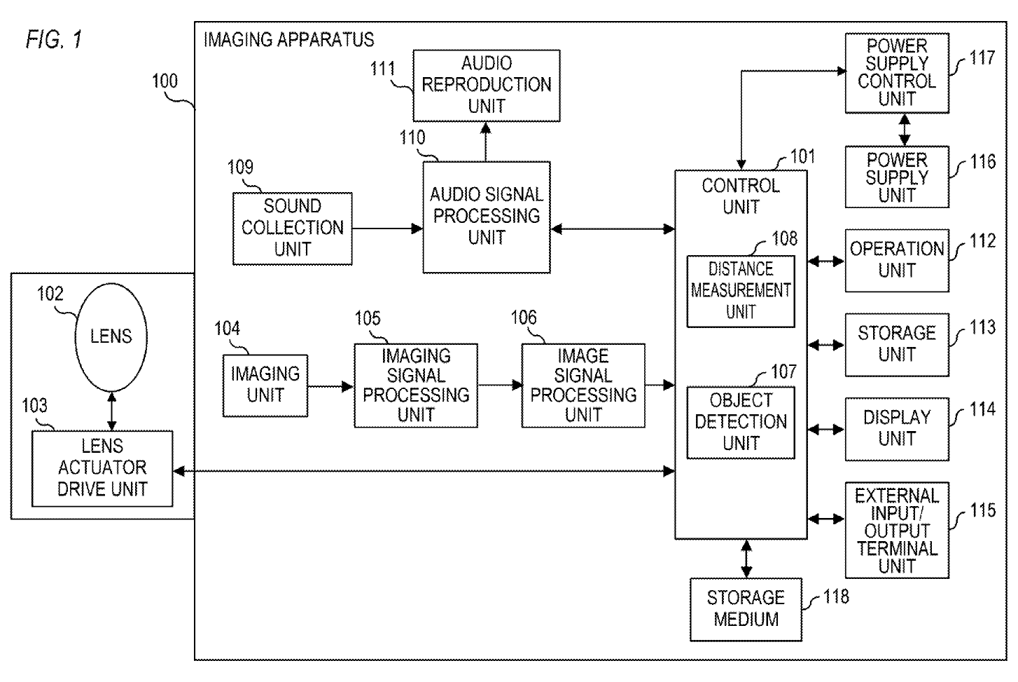

Hereinafter, an embodiment of the present disclosure is described with reference to the drawings. FIG. 1 is a block diagram illustrating a configuration of an imaging apparatus 100, which is an example of an electronic device according to the present disclosure. The electronic device according to the present disclosure may be a smartphone, a tablet terminal, a personal computer (PC), or the like, in addition to the imaging apparatus 100, such as a digital camera. The imaging apparatus 100 includes a control unit 101, a lens 102, and a lens actuator drive unit 103. The control unit 101 is, for example, a central processing unit (CPU) and controls the entire imaging apparatus 100.

The lens 102 is a lens unit, and the lens 102 is a photographing optical system including a zoom unit, a diaphragm/shutter unit, a focus unit, and the like. The lens actuator drive unit 103 includes a motor driver IC and drives various actuators, such as a zoom unit, a diaphragm/shutter unit, and a focus unit, of the lens 102. The lens actuator drive unit 103 drives various actuators based on actuator drive instruction data of the lens 102 received from the control unit 101.

Furthermore, the imaging apparatus 100 includes an imaging unit 104 (imaging device), an imaging signal processing unit 105, and an image signal processing unit 106. The imaging unit 104 includes an imaging element, such as a CMOS sensor and a CCD sensor, photoelectrically converts an optical image formed by the lens 102, and outputs an electric signal. The imaging signal processing unit 105 converts the electrical signal output from the imaging unit 104 into a video signal. The image signal processing unit 106 processes the video signal output from the imaging signal processing unit 105 according to the application. The processing of the video signal includes an electronic vibration-proof operation by image cutout and rotation processing. It should be noted that the imaging unit 104 is also referred to as an imaging unit including the lens 102, the lens actuator drive unit 103, the imaging signal processing unit 105, and the image signal processing unit 106.

The control unit 101 includes an object detection unit 107 and a distance measurement unit 108. The object detection unit 107 detects a person or the like, which is an object, from the image data output from the image signal processing unit 106. The object detection unit 107 can detect a positional relationship between the object and a peripheral wall. The distance measurement unit 108 acquires distance information to a focused object under the control of the lens actuator drive unit 103.

Furthermore, the imaging apparatus 100 includes a sound collection unit 109 (sound collection portion), an audio signal processing unit 110, an audio reproduction unit 111, an operation unit 112, a storage unit 113, a display unit 114, an external input/output terminal unit 115, a power supply unit 116, a power supply control unit 117, and a storage medium 118.

The sound collection unit 109 is an audio input unit including a microphone that converts an audio signal into an electric signal, and the sound collection unit 109 outputs the electric signal to the audio signal processing unit 110. The output signal may be an analog signal or may be an A/D converted digital signal. The sound collection unit 109 may be a microphone having directivity. The sound collection unit 109 may be a built-in microphone mounted on the imaging apparatus 100, an external wired cable microphone, or a cableless microphone. The external wired cable microphone and the cableless microphone are connected to the imaging apparatus 100 by wire via a microphone jack or a multi-accessory shoe mounted on the imaging apparatus 100. An output signal from an external microphone accessory is input to the audio signal processing unit 110.

The audio signal processing unit 110 performs audio processing on the audio signal received from the sound collection unit 109. For example, in a case where the reception signal from the sound collection unit 109 is an analog signal, the audio signal processing unit 110 executes processing of A/D converting the reception signal. The audio reproduction unit 111 includes a speaker, converts audio data into an electrical signal, and reproduces audio.

The operation unit 112 is an operation member for operating the imaging apparatus 100. The operation unit 112 includes a main switch, which is a power switch of the imaging apparatus 100, a volume operation member that corrects a recording gain of audio data, and the like.

The storage unit 113 stores parameters for processing the imaged data, information regarding control of the imaging apparatus 100, information regarding face detection of an object, which is a sound collection target, and the like. The display unit 114 includes a display such as a liquid crystal display (LCD) and displays an image based on a signal output from the image signal processing unit 106. The external input/output terminal unit 115 inputs and outputs a communication signal and a video signal to and from an external device.

The power supply unit 116 supplies power to the entire imaging apparatus 100 (each element) according to the application. The power supply control unit 117 performs control to individually turn on different types of power supply of the power supply unit 116 or turn off the power supply. The storage medium 118 stores video information obtained by photographing by the imaging apparatus 100, audio data collected at the time of photographing, attribute information regarding photographing conditions, and the like.

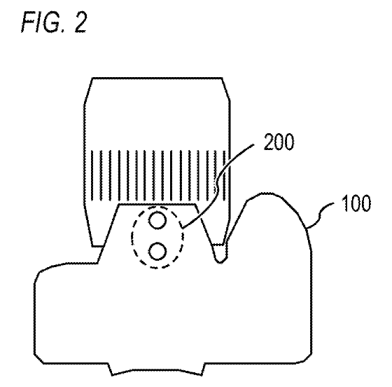

A directional microphone 200 mounted on the imaging apparatus 100 is described with reference to FIG. 2. The directional microphone 200 corresponds to the sound collection unit 109 and the audio signal processing unit 110. The directional microphone 200 generally includes a plurality of microphones. The directional microphone 200 implements sound collection processing by processing audio signals from a plurality of microphones by the audio signal processing unit 110.

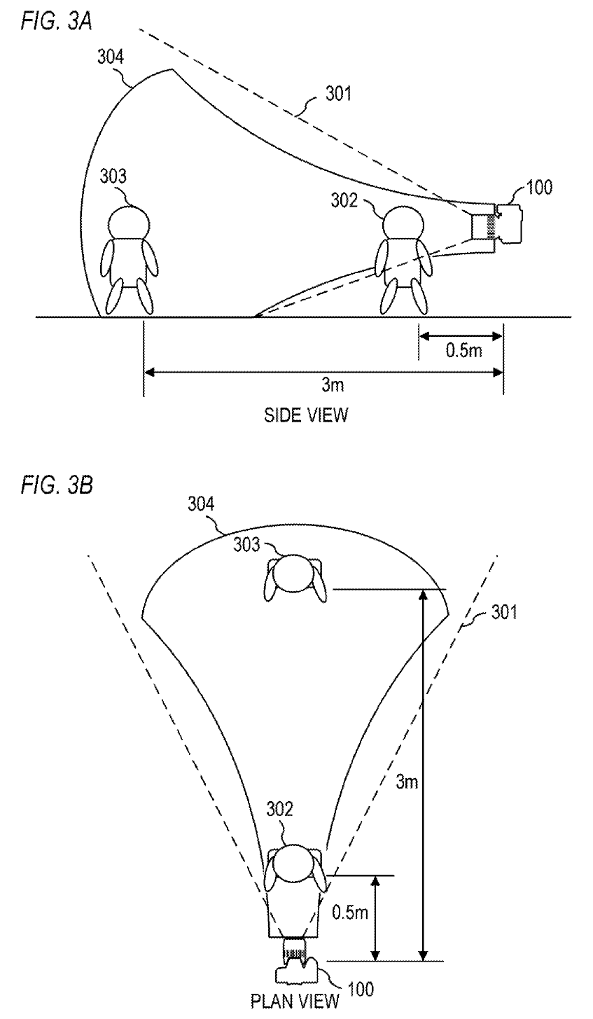

FIGS. 3A and 3B are diagrams illustrating a sound collection range according to a distance between the imaging apparatus 100 and an object. FIG. 3A is a diagram illustrating a sound collection range 304 in a side view, in a case where an object 302 is present at a distance of 0.5 m from the imaging apparatus 100, or in a case where an object 303 is present at a distance of 3 m from the imaging apparatus 100. A view angle range 301 indicated by a dotted line indicates a range of a photographing view angle by the imaging apparatus 100. The sound collection range 304 indicates a sound collection range by the directional microphone 200 mounted on the imaging apparatus 100.

FIG. 3B is a diagram illustrating the sound collection range 304 in a plan view, in a case where the object 302 is present at a distance of 0.5 m from the imaging apparatus 100, or in a case where the object 303 is present at a distance of 3 m from the imaging apparatus 100. The view angle range 301 indicated by a dotted line indicates a range of a photographing view angle by the imaging apparatus 100. The sound collection range 304 indicates a sound collection range by the directional microphone 200 mounted on the imaging apparatus 100.

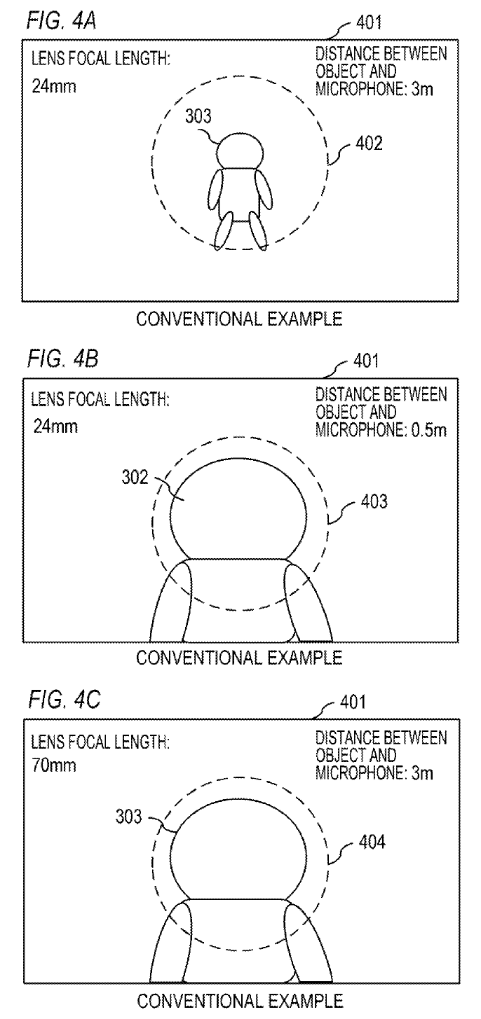

FIGS. 4A to 4C are diagrams illustrating conventional examples of presenting the sound collection range. A display screen 401 in FIGS. 4A to 4C illustrates a region corresponding to the view angle range 301 illustrated in FIGS. 3A and 3B. The display screen 401 in FIGS. 4A to 4C displays a captured image of the view angle range 301 according to the focal length of the lens 102 at each time of image capturing and the distance between the object and the microphone.

The display screen 401 in FIG. 4A illustrates the view angle range 301 in a case where the focal length of the lens 102 is 24 mm, and in a case where the distance from the imaging apparatus 100 (microphone) to the object 303 is 3 m. A sound collectable range 402 is a sound collection possible range, in a case where the focal length of the lens 102 is 24 mm, and in a case where the distance from the microphone to the object 203 is 3 m, and is indicated by a dotted circle near the center of the display screen 401.

The display screen 401 in FIG. 4B illustrates the view angle range 301 in a case where the focal length of the lens 102 is 24 mm, and in a case where the distance from the imaging apparatus (microphone) 100 to the object 302 is 0.5 m. A sound collectable range 403 is a sound collection possible range, in a case where the focal length of the lens 102 is 24 mm, and in a case where the distance from the microphone to the object 302 is 0.5 m, and is indicated by a dotted circle near the center of the display screen 401.

The display screen 401 in FIG. 4C illustrates the view angle range 301 in a case where the focal length of the lens 102 is 70 mm, and in a case where the distance from the imaging apparatus (microphone) 100 to the object 303 is 3 m. A sound collectable range 404 is a sound collection possible range, in a case where the focal length of the lens 102 is 70 mm, and in a case where the distance from the microphone to the object 303 is 3 m, and is indicated by a dotted circle near the center of the display screen 401.

As illustrated in FIGS. 4A to 4C, in the conventional example, even if conditions such as the photographing view angle, the focal length of the lens 102, and the position of the object are changed, the sound collection range is not changed, and the same range is illustrated.

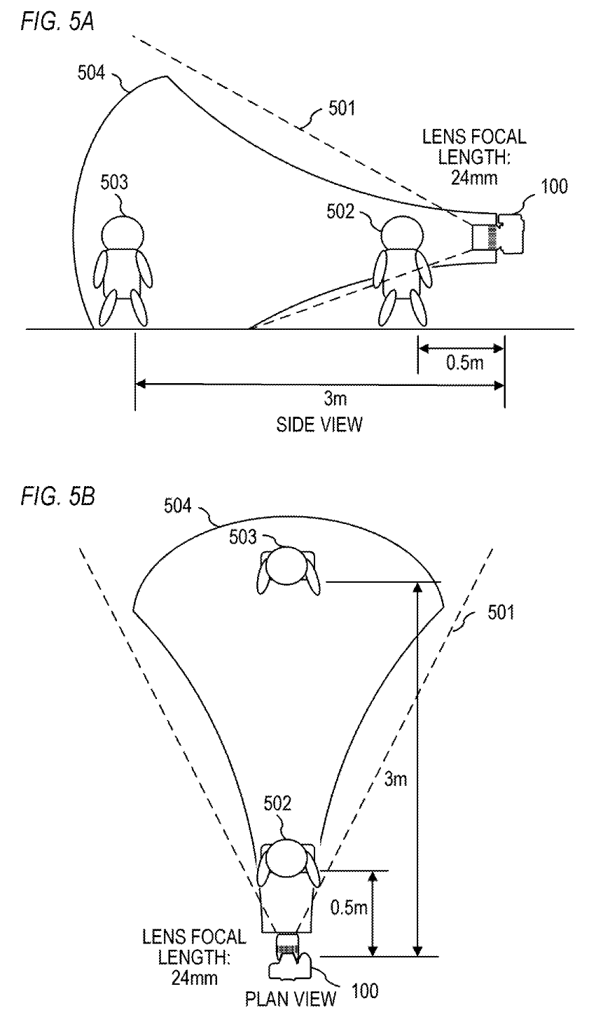

FIGS. 5A and 5B are diagrams illustrating a sound collection range at a first focal length. The first focal length is 24 mm. That is, FIGS. 5A and 5B are diagrams for describing a sound collection range according to the distance between the imaging apparatus 100 and the object in a case where the focal length of the lens 102 is 24 mm. As illustrated in FIG. 2, the imaging apparatus 100 has the directional microphone 200 mounted on the upper surface.

In the same manner as in FIG. 3A, FIG. 5A is a diagram illustrating a sound collection range 504 in a side view, in a case where an object 502 is present at a distance of 0.5 m from the imaging apparatus 100, or in a case where an object 503 is present at a distance of 3 m from the imaging apparatus 100. A view angle range 501 indicated by a dotted line indicates a range of the photographing view angle in a case where the focal length of the lens 102 is 24 mm. The sound collection range 504 indicates a sound collection range by the directional microphone 200 mounted on the imaging apparatus 100.

As illustrated in FIG. 3B, FIG. 5B is a diagram illustrating the sound collection range 504 in a plan view, in a case where the object 502 is present at a distance of 0.5 m from the imaging apparatus 100, or in a case where the object 503 is present at a distance of 3 m from the imaging apparatus 100. The view angle range 501 indicated by a dotted line indicates a range of the photographing view angle in a case where the focal length of the lens 102 is 24 mm. The sound collection range 504 indicates a sound collection range by the directional microphone 200 mounted on the imaging apparatus 100.

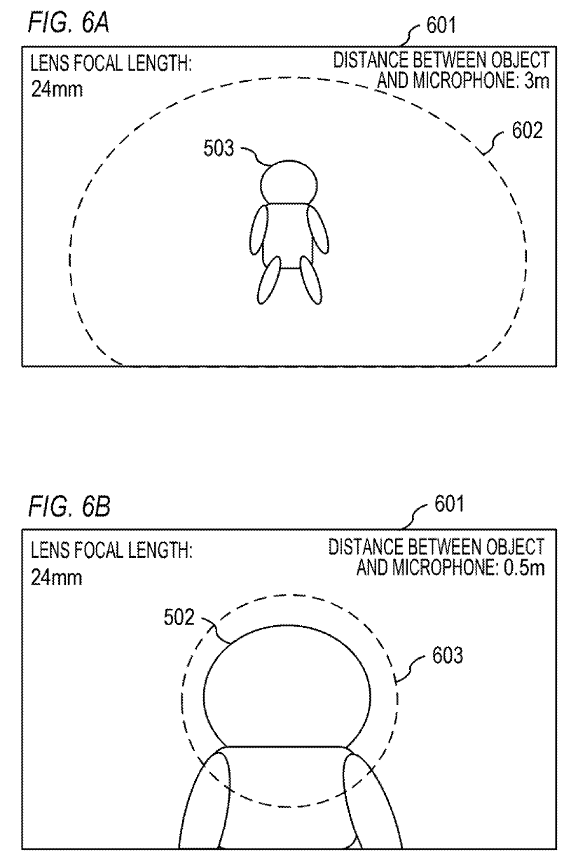

FIGS. 6A and 6B are diagrams illustrating a presentation example of the sound collectable range at the first focal length. The first focal length is 24 mm. A display screen 601 in FIGS. 6A and 6B indicates a region corresponding to the view angle range 501 illustrated in FIGS. 5A and 5B and is displayed on the display unit 114 of the imaging apparatus 100. The display screen 601 in FIGS. 6A and 6B displays a captured image of the view angle range 501 corresponding to a distance between each object and the microphone. The display screen 601 displays a captured image in a mode in which a sound collectable range, which is a range in which audio from an object can be collected in the captured image, can be identified.

The display screen 601 in FIG. 6A illustrates the view angle range 501 in a case where the focal length of the lens 102 is 24 mm, and in a case where the distance from the imaging apparatus 100 (microphone) to the object 503 is 3 m. A sound collectable range 602 is a sound collection possible range in a case where the focal length of the lens 102 is 24 mm, and in a case where the distance from the microphone to the object 503 is 3 m. The sound collectable range 602 is indicated by a dotted circle having a size corresponding to the actual sound collection range 504 by the directional microphone 200 with respect to the display screen 601.

The display screen 601 in FIG. 6B illustrates the view angle range 501 in a case where the focal length of the lens 102 is 24 mm, and in a case where the distance from the imaging apparatus 100 (microphone) to the object 502 is 0.5 m. A sound collectable range 603 is a sound collection possible range, in a case where the focal length of the lens 102 is 24 mm, and in a case where the distance from the microphone to the object 502 is 0.5 m, and is indicated by a dotted circle having a size in which the upper body of the object enters near the center of the display screen 601.

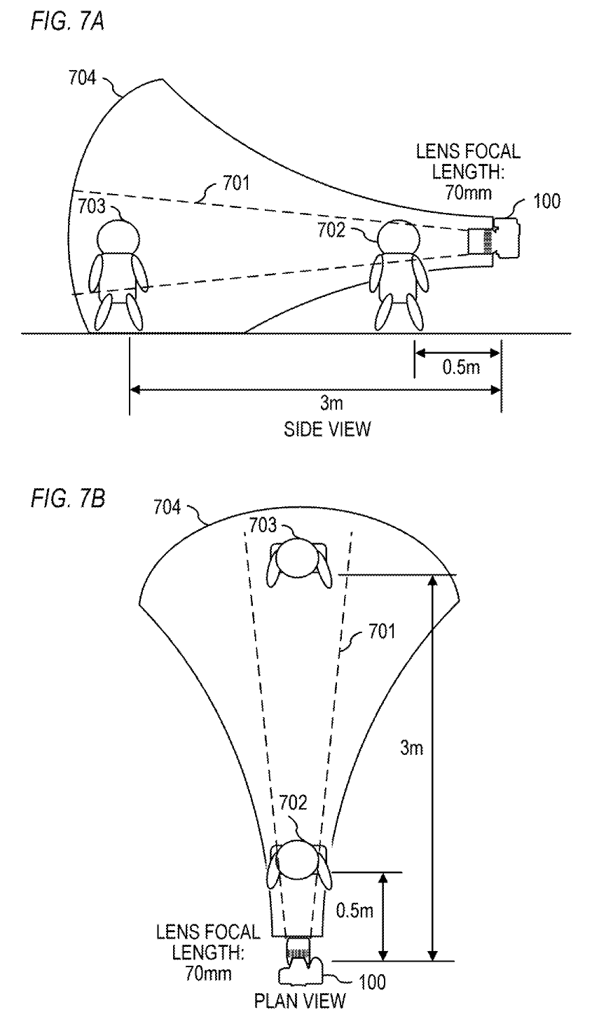

FIGS. 7A and 7B are diagrams illustrating the sound collection range at a second focal length. The second focal length is 70 mm. That is, FIGS. 7A and 7B are diagrams illustrating a sound collection range according to the distance between the imaging apparatus 100 and the object in a case where the focal length of the lens 102 is 70 mm. As illustrated in FIG. 2, the imaging apparatus 100 has the directional microphone 200 mounted on the upper surface.

FIG. 7A is a diagram illustrating a sound collection range 704 in a side view, in a case where an object 702 is present at a distance of 0.5 m from the imaging apparatus 100, or in a case where an object 703 is present at a distance of 3 m from the imaging apparatus 100. A view angle range 701 indicated by a dotted line indicates a range of the photographing view angle in a case where the focal length of the lens 102 is 70 mm. The sound collection range 704 indicates a sound collection range by the directional microphone 200 mounted on the imaging apparatus 100.

FIG. 7B is a diagram illustrating the sound collection range 704 in a plan view, in a case where the object 702 is present at a distance of 0.5 m from the imaging apparatus 100, or in a case where the object 703 is present at a distance of 3 m from the imaging apparatus 100. The view angle range 701 indicated by a dotted line indicates a range of the photographing view angle in a case where the focal length of the lens 102 is 70 mm. The sound collection range 704 indicates a sound collection range by the directional microphone 200 mounted on the imaging apparatus 100.

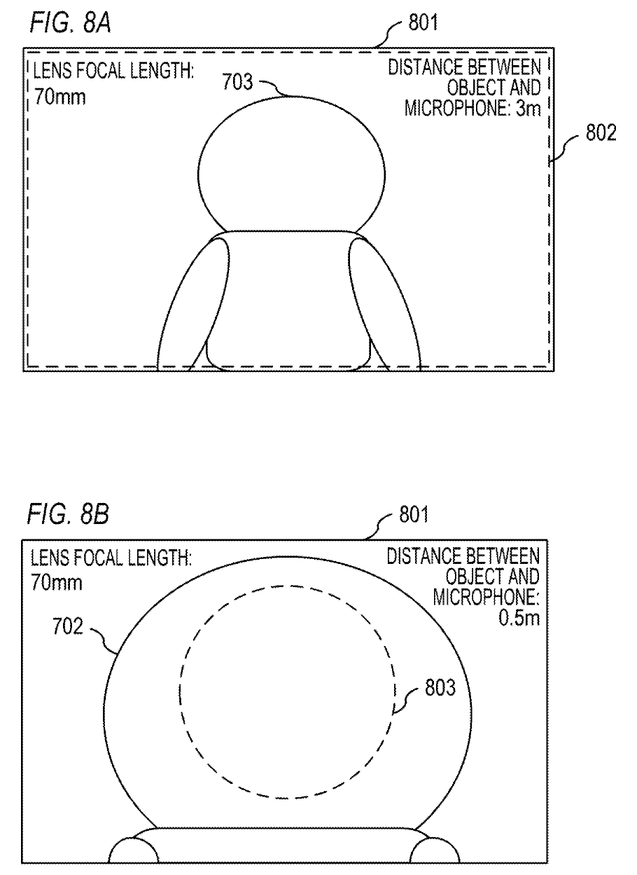

FIGS. 8A and 8B are diagrams illustrating a presentation example of the sound collection range at the second focal length. The second focal length is 70 mm. A display screen 801 in FIGS. 8A and 8B indicates a region corresponding to the view angle range 701 illustrated in FIGS. 7A and 7B and is displayed on the display unit 114 of the imaging apparatus 100. The display screen 801 in FIGS. 8A and 8B displays a captured image of the view angle range 701 corresponding to a distance between each object and the microphone. The display screen 801 displays a captured image in a mode in which a sound collectable range, which is a range in which audio from an object can be collected in the captured image, can be identified.

The display screen 801 in FIG. 8A illustrates the view angle range 701 in a case where the focal length of the lens 102 is 70 mm, and in a case where the distance from the imaging apparatus 100 (microphone) to the object 703 is 3 m. A sound collectable range 802 indicates a sound collection possible range within the view angle range 701 and is indicated by a dotted rectangle along the periphery of the display screen 801. The actual sound collection range 704 under the condition that the focal length of the lens 102 is 70 mm and the distance from the imaging apparatus 100 (microphone) to the object 703 is 3 m is wider than the view angle range 701. Therefore, the view angle range 701 shown on the display screen 801 is a range in which sound can be collected by the directional microphone 200.

The display screen 801 in FIG. 8B illustrates the view angle range 701 in a case where the focal length of the lens 102 is 70 mm, and in a case where the distance from the imaging apparatus 100 (microphone) to the object 702 is 0.5 m. A sound collectable range 803 is a sound collection possible range, in a case where the focal length of the lens 102 is 70 mm, and in a case where the distance from the microphone to the object 702 is 0.5 m, and is indicated by a dotted circle having a size about the center of the face of the object near the center of the display screen 801.

The sound collectable range changes according to the conditions of the photographing view angle, the focal length of the lens 102, and the distance from the imaging apparatus to the object. The imaging apparatus 100 displays the captured image on the display unit 114 in a mode in which the actual sound collectable range can be identified based on the conditions of the photographing view angle, the focal length of the lens 102, and the distance from the imaging apparatus to the object. Therefore, the user who is the photographer can perform photographing while confirming the appropriately presented sound collectable range.

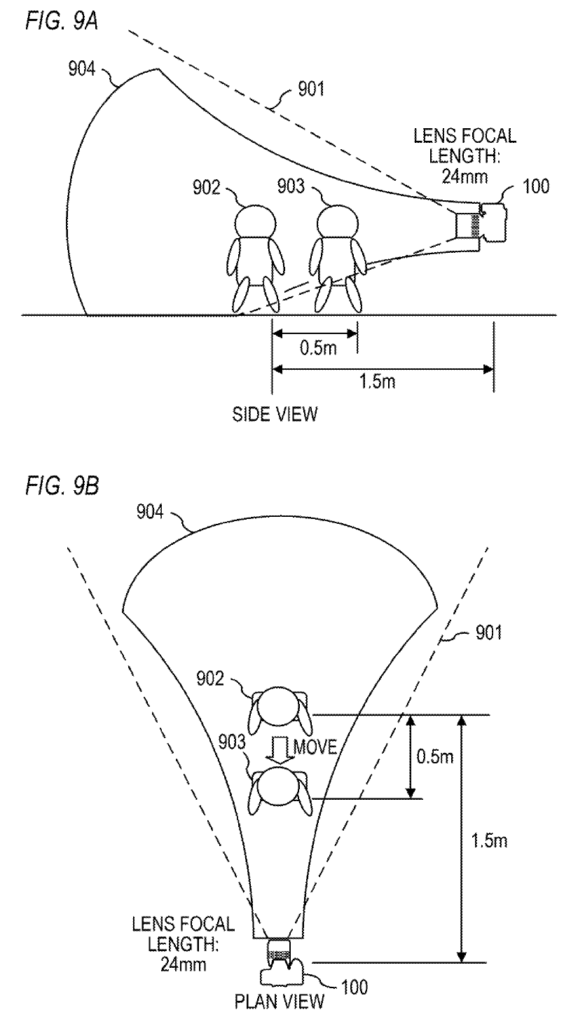

FIGS. 9A and 9B are diagrams illustrating the sound collection range when the object moves. When the object moves in a state where the sound collection range is presented, the sound collection range is changed according to the distance between the object after the movement and the imaging apparatus 100. As illustrated in FIG. 2, the imaging apparatus 100 has the directional microphone 200 mounted on the upper surface.

FIG. 9A is a diagram illustrating a sound collection range 904 in a side view in a state where an object 902 at a distance of 1.5 m from the imaging apparatus 100 is moved by 0.5 m toward the imaging apparatus 100. An object 903 is the object 902 after movement. A view angle range 901 indicated by a dotted line indicates a range of the photographing view angle in a case where the focal length of the lens 102 is 24 mm. The sound collection range 904 indicates a sound collection range by the directional microphone 200 mounted on the imaging apparatus 100.

FIG. 9B is a diagram illustrating the sound collection range 904 in a plan view in a state where the object 902 at a distance of 1.5 m from the imaging apparatus 100 is moved by 0.5 m toward the imaging apparatus 100. The view angle range 901 indicated by a dotted line indicates a range of the photographing view angle in a case where the focal length of the lens 102 is 24 mm. The sound collection range 904 indicates a sound collection range by the directional microphone 200 mounted on the imaging apparatus 100.

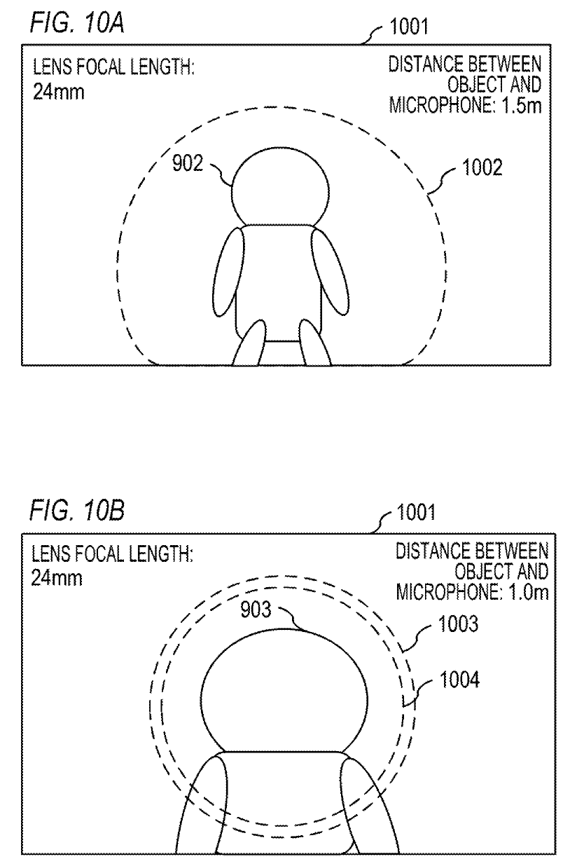

FIGS. 10A and 10B are diagrams illustrating a presentation example of the sound collectable range when the object moves. A display screen 1001 in FIG. 10A illustrates the view angle range 901 in a case where the focal length of the lens 102 is 24 mm, and in a case where the distance from the imaging apparatus 100 (microphone) to the object 902 is 1.5 m. A sound collectable range 1002 indicates a sound collection possible range within the view angle range 901 and is indicated by a dotted circle to the extent that the range from the head to the knee of the object 902 is included.

The display screen 1001 in FIG. 10B illustrates the view angle range 901 in a case where the focal length of the lens 102 is 24 mm, and in a case where the distance from the imaging apparatus 100 (microphone) to the object 903 is 1.0 m. A sound collectable range 1003 indicates a sound collection possible range in a case where the object 902 moves to the position of the object 903 by 0.5 m toward the imaging apparatus 100.

The sound collectable range 1003 indicates a sound collection possible range in a case where the distance from the microphone to the object 903 is 1.0 m and is indicated by a dotted circle having a size in which the upper body of the object enters near the center of the display screen 1001.

It should be noted that the control unit 101 may present, on the display screen 1001, a sound collectable range 1004 smaller than the actual sound collectable range 1003 in order to notify the user that the sound collectable range is gradually reduced during the movement of the object 902. When the object 902 stops at the position of the object 903, the control unit 101 returns the sound collectable range 1004 to the sound collectable range 1003 and presents the sound collectable range to the user.

The distance between the imaging apparatus 100 and the object taken into consideration when determining the sound collectable range is a distance in the optical axis direction of the imaging unit (lens 102). Even when the object is moving in an oblique direction with respect to the optical axis direction, the imaging apparatus 100 determines the sound collectable range to be presented based on the distance between the imaging apparatus 100 and the object in the optical axis direction.

It should be noted that, not only in a case where the object approaches the imaging apparatus 100, but also in a case where the object moves in a direction away from the imaging apparatus 100, the control unit 101 may notify the change in the sound collectable range early. When the object moves in a direction away from the imaging apparatus 100, the sound collectable range is presented to be larger than the actual sound collectable range. As described above, when the object is moving in the optical axis direction of the imaging unit (lens 102), the control unit 101 predicts the sound collectable range after a predetermined period of time and performs control to display the captured image in a mode in which the predicted sound collectable range can be identified.

As in the sound collectable range 1004 described in FIG. 10B, the intention of the display control to display the sound collectable range smaller than the actual sound collectable range 1003 is to enable the user, who is the photographer, to grasp the change in the sound collectable range early. Even during the movement of the object, the size of the sound collectable range is changed according to the moving distance of the object. However, when the object moves in a direction approaching the imaging apparatus 100, the appropriate sound collectable range is narrowed, and the object easily deviates from the sound collectable range. Therefore, in order to enable the user to grasp the change in the sound collectable range early, the imaging apparatus 100 displays the sound collectable range to be smaller than the actual sound collectable range. By controlling the presentation of the sound collectable range in this manner, the user can notice at an early stage even when the object moves out of the sound collectable range and can take measures such as moving the view angle.

In FIGS. 10A and 10B, the imaging apparatus 100 presents the sound collectable range while changing the sound collectable range according to the movement of the object. Therefore, the user can perform photographing while confirming the appropriate sound collectable range.

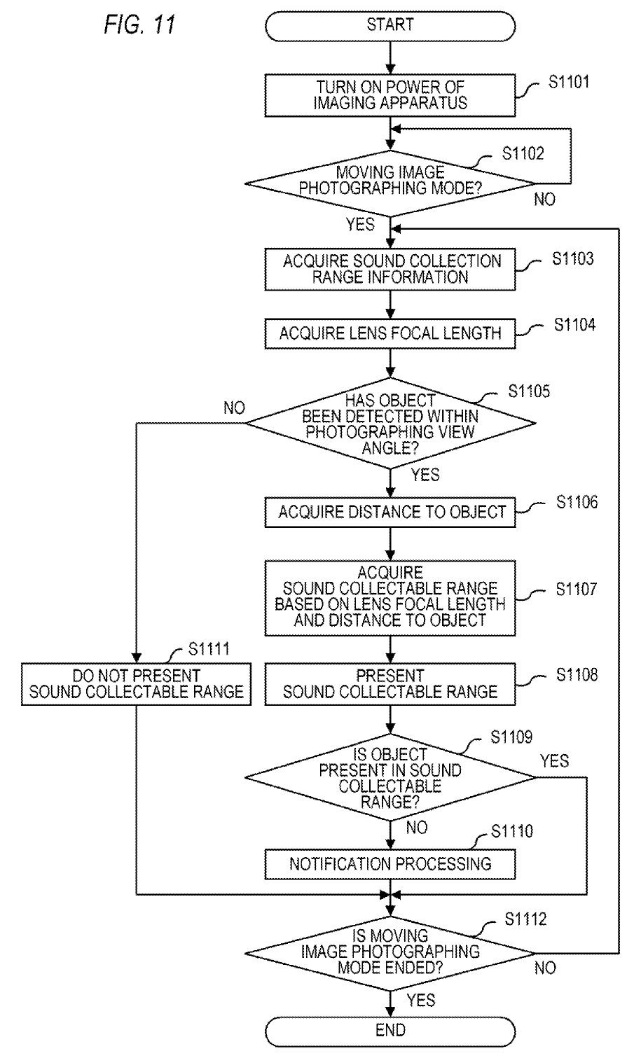

FIG. 11 is a flowchart illustrating presentation processing of the sound collectable range. The presentation processing of the sound collectable range is display control processing of displaying the captured image in a mode in which the sound collectable range, which is a range in which the sound from the object can be collected in the captured image, can be identified. In step S1101, the control unit 101 detects an operation on the power switch of the operation unit 112 from the user and turns on the power of the imaging apparatus 100.

In step S1102, the control unit 101 determines whether the imaging apparatus 100 is set to the moving image photographing mode. When the imaging apparatus 100 is set to the moving image photographing mode, the processing proceeds to step S1103. When the imaging apparatus 100 is not set to the moving image photographing mode, the control unit 101 returns to step S1102 and repeats processing of determining whether the imaging apparatus is in the moving image photographing mode until the moving image photographing mode is set. The state determined to be the moving image photographing mode includes a moving image recording state, a moving image recording standby state (live view state), and other states related to moving image recording.

In step S1103, the control unit 101 acquires sound collection range information of the directional microphone 200. The sound collection range information of the directional microphone 200 is stored in advance in the storage unit 113 or the like. The sound collection range information is, for example, information of a sound collection range of a microphone that changes so as to spread according to a distance from the directional microphone 200 mounted on the imaging apparatus 100, such as the sound collection range 304 illustrated in FIG. 3A. The sound collection range can be a range of a distance (distance from the directional microphone 200) and an angle (angle with respect to the axis of the directional microphone 200) in which sound of a predetermined frequency can be recorded at a predetermined recording level or higher. In step S1104, the control unit 101 acquires information on the focal length of the lens 102 attached to the imaging apparatus 100.

In step S1105, the object detection unit 107 determines whether an object (for example, a person) has been detected within the photographing view angle range from the captured image captured by the imaging unit 104. In a case where the object is detected, the processing proceeds to step S1106. In a case where the object is not detected, the processing proceeds to step S1111.

In step S1106, the distance measurement unit 108 acquires the distance from the imaging apparatus 100 to the object detected by the object detection unit 107 based on the focus information acquired by the lens actuator drive unit 103.

In step S1107, the control unit 101 acquires the information of the sound collectable range based on the information of the sound collection range by the directional microphone 200, the focal length of the lens 102, and the distance from the imaging apparatus 100 to the object. The sound collectable range is a range in which the audio from the object can be collected in the captured image.

In step S1108, the display unit 114 presents the sound collectable range acquired in step S1107. The display unit 114 may display the captured image (live view image) in a mode in which the sound collectable range can be identified.

The sound collectable range is presented on the display screen 601 by being surrounded by a dotted line, for example, as in the sound collectable range 602 in FIG. 6A and the sound collectable range 603 in FIG. 6B. The sound collectable range 602 and the sound collectable range 603 indicate ranges in which the sound collection ranges 504 in FIGS. 5A and 5B are represented on the plane of the display screen 601.

Similarly, the sound collectable range is presented on the display screen 801 by being surrounded by a dotted line as in the sound collectable range 802 in FIG. 8A and the sound collectable range 803 in FIG. 8B. The sound collectable range 802 and the sound collectable range 803 indicate ranges in which the sound collection ranges 704 in FIGS. 7A and 7B are represented on the plane of the display screen 801. It should be noted that the sound collectable range is not limited to the case of being surrounded by a dotted line and may be surrounded by a solid line, blinked, or presented in various modes.

In step S1109, the control unit 101 determines whether the object detected in step S1105 is present within the sound collectable range presented in step S1108. When the object is present within the sound collectable range, the processing proceeds to step S1112. In a case where the object is not present within the sound collectable range, the processing proceeds to step S1110.

In a case where the object has not been detected in step S1109, in step S1110, in a case where the object is not present within the sound collectable range, the control unit 101 notifies the photographer or the object of the fact. The control unit 101 can notify the photographer and the object, for example, by a notification sound and LED display. The notification by the notification sound and the LED display may be performed by the imaging apparatus 100 or may be performed by an external device capable of communicating with the imaging apparatus 100. By recognizing that the object is not present in the sound collectable range, the photographer can adjust the photographing view angle so that the object is included in the sound collectable range. In addition, the object can move into the sound collectable range by recognizing that the object is out of the sound collectable range.

When the object is not detected within the photographing view angle in step S1105, the control unit 101 does not present the sound collectable range in step S1111 and proceeds to step S1112. This is because, in a case where the object is not detected, an appropriate sound collectable range according to the distance between the imaging apparatus 100 and the object is not acquired. It should be noted that, even when the object is not detected, in a case where it is predicted that the object enters the view angle, the control unit 101 may acquire and present the sound collectable range based on the predicted position of the object and the distance between the object and the imaging apparatus 100.

In step S1112, the control unit 101 determines whether the moving image photographing mode is ended. When the moving image photographing mode is ended, the control unit 101 ends the presentation processing of the sound collectable range illustrated in FIG. 11. When the moving image photographing mode is not ended, the processing returns to acquisition processing of the sound collection range information in step S1103. The control unit 101 repeats the processing from step S1103 to step S1111 until the moving image photographing mode is ended.

It should be noted that the object to be detected in step S1105 can be a person registered in advance in the storage unit 113. The object detection unit 107 may detect a person to be an object by collating a captured image captured by the imaging unit 104 with a face image of a person registered in the storage unit 113. The object to be detected is not limited to a person, and the object detection unit 107 may also detect an animal or the like.

Furthermore, as described with reference to FIGS. 10A and 10B, when the object is moving in the optical axis direction of the imaging unit (lens 102), the control unit 101 predicts the sound collectable range after a predetermined period of time and performs control to present the predicted sound collectable range, but the control may not be performed. Whether to perform control to present the sound collectable range after a predetermined period of time during the movement of the object may be set by the user. For example, the user can switch on/off of the control for presenting the sound collectable range after a predetermined period of time on the menu screen displayed on the display unit 114. When the control for presenting the sound collectable range after the predetermined period of time is set to ON, the control unit 101 predicts the position of the object after the predetermined period of time from the positional relationship between the object in the previous frame and the object in the current frame in the processing from step S1103 to step S1108. The control unit 101 can predict the sound collection range after a predetermined period of time by using the predicted position of the object and the distance between the object and the imaging apparatus 100.

In addition, for example, ease of sound spreading is different between indoors and outdoors. Therefore, the control unit 101 may perform control so that the size of the sound collectable range presented in the captured image varies depending on sound collection conditions such as whether the captured image is captured indoors or the captured image is captured outdoors.

In an indoor environment rather than an outdoor environment, the sound collection range of the directional microphone 200 tends to be wider due to reflected sound from surrounding walls or the like. Therefore, when the conditions of the distance from the imaging apparatus 100 to the object and the focal length of the lens 102 are the same between indoors and outdoors, the control unit 101 performs control so that the size of the sound collectable range in the captured image captured indoors is larger than that of outdoors.

For example, in step S1107, the control unit 101 can determine whether the surrounding environment is indoor or outdoor based on the captured image. Specifically, when a wall is present around the object in the captured image, the control unit 101 can determine that the captured image has been captured indoors. Furthermore, the control unit 101 may determine that the captured image is captured indoors when the distance between the object and the background is shorter than a predetermined threshold value in the captured image, and may determine that the captured image is captured outdoors when the distance between the object and the background is equal to or greater than the predetermined threshold value in the captured image.

It should be noted that the sound collection condition is not limited to whether the surrounding environment is indoor or outdoor, and the control unit 101 may perform control so that the size of the sound collectable range in the captured image varies, for example, depending on whether the volume from the surroundings other than the object is larger than the threshold value or equal to or smaller than the threshold value. As described above, the control unit 101 can perform control so that the size of the sound collectable range presented in the captured image varies according to the sound collection condition in the environment where the captured image is captured.

According to the above embodiment, the imaging apparatus 100 displays the captured image in a mode in which the sound collectable range can be identified in the captured image based on the distance from the imaging apparatus 100 to the object, the focal length of the lens 102, and the information of the sound collection range of the directional microphone 200. As a result, the user can appropriately determine the photographing view angle while more accurately grasping the range in which the sound from the object can be collected.

Note that the above-described various types of control may be processing that is carried out by one piece of hardware (e.g., processor or circuit), or otherwise.

Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, a user can determine a photographing view angle while more accurately grasping a range in which audio of an object can be collected.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-030172, which was filed on Feb. 27, 2025 and which is hereby incorporated by reference herein in its entirety.

What is claimed is:

1. An electronic device comprising:
a processor; and
a memory storing instructions that, when executed by the processor, cause the electronic device to:
execute detection processing of detecting an object from a captured image captured by an imaging device, and
execute display control processing of performing control to display the captured image in a mode in which a sound collectable range, which is a range in which audio from the object is collectable in the captured image, is identifiable based on a distance from the imaging device to the object, a focal length of the imaging device, and information of a sound collection range by a sound collection unit that collects audio to be recorded together with the captured image.

2. The electronic device according to claim 1,
wherein in the detection processing, a person or an animal is detected as the object.

3. The electronic device according to claim 1,
wherein in the display control processing, when the object moves in an optical axis direction of the imaging device, the sound collectable range after a predetermined period of time is predicted, and the captured image is controlled to be displayed in a mode in which a predicted sound collectable range is identifiable.

4. The electronic device according to claim 3,
wherein whether to perform control of displaying the captured image in a mode in which the predicted sound collectable range is identifiable is set by a user.

5. The electronic device according to claim 1,
wherein in the display control processing, a size of the sound collectable range in the captured image is controlled to vary depending on whether the captured image is captured in a first environment or the captured image is captured in a second environment having a sound collection condition different from that of the first environment.

6. The electronic device according to claim 5,
wherein in the display control processing, in a case where the first environment is indoor, and the second environment is outdoor, if conditions of the distance from the imaging device to the object and the focal length of the imaging device are the same between the indoor and the outdoor, the size of the sound collectable range in the captured image captured indoors is controlled to be larger than the size of the sound collectable range in the captured image captured outdoors.

7. The electronic device according to claim 6,
wherein in the display control processing, in a case where a wall is present around the object in the captured image, it is determined that the captured image is captured indoors.

8. The electronic device according to claim 6,
wherein in the display control processing,
in a case where a distance between the object and background is shorter than a predetermined threshold value in the captured image, it is determined that the captured image is captured indoors, and
in a case where the distance between the object and the background is a predetermined threshold value or more in the captured image, it is determined that the captured image is captured outdoors.

9. The electronic device according to claim 1,
wherein the sound collection unit has directivity.

10. A method of controlling an electronic device, the method comprising:
detecting an object from a captured image captured by an imaging device, and
performing control to display the captured image in a mode in which a sound collectable range, which is a range in which audio from the object is collectable in the captured image, is identifiable based on a distance from the imaging device to the object, a focal length of the imaging device, and information of a sound collection range by a sound collection unit that collects audio to be recorded together with the captured image.

11. A non-transitory computer-readable medium that stores computer-executable instructions that, when executed by a computer, causes the computer to execute a method of controlling an electronic device, the method comprising:
detecting an object from a captured image captured by an imaging device, and
performing control to display the captured image in a mode in which a sound collectable range, which is a range in which audio from the object is collectable in the captured image, is identifiable based on a distance from the imaging device to the object, a focal length of the imaging device, and information of a sound collection range by a sound collection unit that collects audio to be recorded together with the captured image.
